(19) United States
(12) Patent Application Publication
(10) Pub. No.: US 2025/0214455 A1
(43) Pub. Date: Jul. 3, 2025

(54) Modular Fuel Cell Assembly And Liquid Hydrogen Tank For A Work Vehicle

(71) Applicant: Komatsu America Corp., Chicago, IL (US)

(72) Inventors: Kory LEESMAN, Atlanta, IL (US); Hou Chiao TSENG, Glenview, IL (US); Zachary Charles UPPOLE, Pekin, IL (US)

(73) Assignee: Komatsu America Corp., Chicago, IL (US)

(21) Appl. No.: 18/985,815

(22) Filed: Dec. 18, 2024

Related U.S. Application Data
(60) Provisional application No. 63/614,246, filed on Dec. 22, 2023.

(51) Int. Cl. B60L 50/71; B60K 15/03; B60L 50/72

(52) U.S. Cl. CPC B60L 50/71; B60K 15/03; B60L 50/72; B60K 2015/03256; B60K 2015/03315; B60L 2200/40

(57) ABSTRACT

A work vehicle includes a chassis having frame rails, a cargo bed disposed along the chassis, an electric motor disposed on the chassis, one or more fuel cell enclosures disposed under the cargo bed, and a hydrogen tank disposed above the one or more fuel cell enclosures. The one or more fuel cell enclosures include a plurality of fuel cells configured to be inserted into the one or more fuel cell enclosures, and one or more leak-free valves configured to couple the plurality of fuel cells with the work vehicle.

### CROSS-REFERENCE TO RELATED APPLICATIONS

This application claims the benefit of U.S. Provisional Application No. 63/614,246, filed on Dec. 22, 2023. The entire disclosure of the above application is incorporated herein by reference.

### FIELD

The present disclosure relates to the art of work vehicles including mining trucks and, more particularly, to a modular fuel cell assembly and a liquid hydrogen tank for a work vehicle.

### BACKGROUND AND SUMMARY

A work vehicle may be used for off-road applications, such as mining, construction, and the like. Many work vehicles are powered by diesel engines or natural gas engines. To reduce carbon emission, work vehicles may include hydrogen fuel cells as primary power sources.

Hydrogen fuel cells are useful sources of electrical energy, which may be used to power a work vehicle. A hydrogen fuel cell includes a cathode and an anode, which surround an electrolyte. When hydrogen is provided to the anode, and oxygen is provided to the cathode, electrons from the hydrogen molecules flow from the anode to the cathode to create a flow of electricity. Oxygen and water are byproducts of this process. A plurality of individual fuel cells can be arranged together into a fuel cell stack to produce a desired voltage output. A hydrogen fuel cell system for a vehicle may also include a hydrogen source (e.g., one or more hydrogen tanks) and an energy storage component (e.g., one or more batteries).

A fuel-cell-powered work vehicle may include a lot of fuel cells to meet the required power output. If one of the fuel cells in a fuel cell stack malfunctions or needs maintenance or repair, the entire fuel cell assembly may need to be taken offline and removed. Removing the entire fuel cell assembly would put the work vehicle out of commission creating a large downtime. Moreover, mine sites may not have fuel cell technicians on site to make repairs and the entire fuel cell assembly may need to be transported off-site for service leading to even greater idle periods for the work vehicle. Thus, there is a need for a universal design related to fuel cell systems that includes hot swapping, e.g., exchanging without interrupting the operation, individual fuel cells in the field, reducing maintenance time and improving reliability.

### SUMMARY

A work vehicle, in accordance with the present disclosure, includes a chassis having frame rails, a cargo bed disposed along the chassis, an electric motor disposed on the chassis, one or more fuel cell enclosures disposed under the cargo bed, and a hydrogen tank disposed above the one or more fuel cell enclosures. The one or more fuel cell enclosures include a plurality of fuel cells configured to be inserted into the one or more fuel cell enclosures, and one or more leak-free valves configured to couple the plurality of fuel cells with the work vehicle.

In other features, the plurality of fuel cells are disposed on a tray removably inserted into the one of the fuel cell enclosures, and the one or more leak-free valves are disposed on the tray and is configured to couple the plurality of fuel cells with the work vehicle.

In other features, a conduit configured to couple the plurality of fuel cells and the one or more leak-free valves.

In other features, the conduit is disposed on the tray.

In other features, the one or more leak-free valves is a multi-port connection coupling having a first plate, a second plate configured to mate with the first plate, and one or more couplers disposed between the first plate and the second plate so that a plurality of fluid flows are enabled through the multi-port connection coupling.

In other features, the multi-port connection coupling comprises a sensor that detects abnormality of a connection between the first plate and the second plate.

In other features, the sensor is configured to output an alert when a level of vibration in the one or more fuel cell enclosures exceeds a predetermined threshold.

In other features, the one or more fuel cell enclosures include a first fuel cell enclosure and a second fuel cell enclosure, and the first fuel cell enclosure and the second fuel cell enclosure are arranged on an opposite side of the chassis.

In other features, the chassis includes a first frame rail and a second frame rail, and the first and second fuel cell enclosures are respectively attached to the first and second frame rails.

In other features, in each of the first and second fuel cell enclosures, the plurality of fuel cells are disposed on a tray removably inserted into the first and second fuel cell enclosures, and the trays of each of the first and second fuel cell enclosures are respectively configured to be put in and out of the first and second fuel cell enclosures.

In other features, each of the one or more fuel cell enclosures includes an air filter configured to filter air passing into the one or more fuel cell enclosures to each of the plurality fuel cells.

A work vehicle in accordance with the present disclosure, includes a chassis having frame rails, a cargo bed disposed along the chassis, an electric motor disposed on the chassis, one or more fuel cells disposed under the cargo bed, and a hydrogen tank disposed above the one or more fuel cells. The cargo bed has a recess portion; and the hydrogen tank is disposed under the recess portion.

In other features, the recess portion is recessed towards an upper surface of the cargo bed, and the hydrogen tank is disposed under the recess portion, the hydrogen tank extending along a recessed surface of the recess portion.

A work vehicle, in accordance with the present disclosure, includes a chassis having frame rails, a cargo bed disposed along the chassis, a deck with an operator cab fixed on the chassis, an electric motor disposed on the chassis, one or more fuel cells disposed under the cargo bed, and a hydrogen tank disposed in a vicinity of the deck.

In other features, the hydrogen tank is disposed behind the deck.

In other features, the hydrogen tank is disposed between the frame rails of the chassis.

In other features, the hydrogen tank is disposed above one of front wheels.

In other features, the hydrogen tank is disposed on the deck.

### DRAWINGS

FIG. 1 is a side view of a work vehicle having a modular fuel cell assembly and liquid hydrogen storage tank, in accordance with the present disclosure;

FIG. 2 is a partial perspective view of a portion of the work vehicle of FIG. 1 illustrating a fuel cell enclosure of the modular fuel cell assembly, in accordance with the present disclosure;

FIG. 3 is a partially disassembled view of a fuel cell enclosure of the modular fuel cell assembly of FIG. 2, in accordance with the present disclosure;

FIG. 4 is a perspective view a fuel cell pack of the modular fuel cell assembly of FIG. 3 including a multi-coupling interface (MCI), in accordance with the present disclosure;

FIG. 5A is a disassembled view of the MCI of FIG. 4 depicting a first plurality of connectors on a first interface member, in accordance with the present disclosure;

FIG. 5B is a disassembled view of the MCI of FIG. 4 depicting a second plurality of connectors on a second interface member, in accordance with the present disclosure;

FIG. 6 is a perspective view of another one of the fuel cell assemblies, in accordance with an aspect of the present disclosure;

FIG. 7 is a schematic illustration of multiple fuel cell packs of the fuel cell assembly of FIG. 2 connected to various systems of the work vehicle, in accordance with the present disclosure;

FIG. 8 is a perspective view of the fuel cell assemblies and enclosures and a fuel tank mounted to a chassis of the work vehicle of FIG. 1, in accordance with the present disclosure;

FIG. 9 is a perspective view of the work vehicle of FIG. 1 depicting an alternative mounting arrangement for the fuel tank, in accordance with the present disclosure;

FIG. 10 is a perspective view of the work vehicle of FIG. 1 depicting another alternative mounting arrangement for the fuel tank, in accordance with the present disclosure;

FIG. 11 is a left side view of the work vehicle of FIG. 1 depicting yet another alternative mounting arrangement for the fuel tank, in accordance with the present disclosure;

FIG. 12 is partial side view of the work vehicle of FIG. 11 illustrating the yet another mounting arrangement of the fuel tank, in accordance with the present disclosure;

FIG. 13 is a perspective view of the work vehicle of FIG. 11 with the fuel tank removed, in accordance with the present disclosure;

FIG. 14 is another perspective view of the work vehicle and fuel tank of FIG. 11, in accordance with the present disclosure;

FIG. 15 is a rear perspective view of a dump bed of the work vehicle of FIG. 11, in accordance with the present disclosure;

FIG. 16 is a left side view of another configuration of the work vehicle and fuel tank, in accordance with the present disclosure;

FIG. 17 is a partial side view of fuel tank placement on the work vehicle of FIG. 1, in accordance with an aspect of the present disclosure;

FIG. 18 is a partial side view of fuel tank placement on the work vehicle of FIG. 1, in accordance with another aspect of the present disclosure;

FIG. 19 is a partial side view of yet another configuration of a vehicle and fuel tank, in accordance with the present disclosure;

FIG. 20 is a partial side view of fuel tank placement on the work vehicle of FIG. 1, in accordance with yet another aspect of the present disclosure;

FIG. 21 is a partial side view of fuel tank placement on the work vehicle of FIG. 1, in accordance with still yet another aspect of the present disclosure;

FIG. 22 is a partial side view of fuel tank placement on the work vehicle of FIG. 1, in accordance with yet still another aspect of the present disclosure;

FIG. 23 is a partial side view of fuel tank placement on the work vehicle of FIG. 1, in accordance with a further aspect of the present disclosure; and

FIG. 24 is a partial side view of fuel tank placement on the work vehicle of FIG. 1, in accordance with yet a further aspect of the present disclosure.

### DETAILED DESCRIPTION

It is to be understood that the disclosure is not limited in its application to the details of construction and the arrangement of components set forth in the following description or illustrated in the following drawings. The disclosure is capable of other embodiments and of being practiced or of being carried out in various ways.

Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Unless specified or limited otherwise, the terms “mounted,” “connected,” “supported,” “coupled” and variations thereof are used broadly and encompass both direct and indirect mountings, connections, supports, and couplings.

In general, the present disclosure relates to a fuel cell system for a work truck (e.g., a mining truck). The fuel cell system may include a fuel cell enclosure with a stack of removable fuel cell assemblies with various features for rapid replacement of failed fuel cells without individually disconnecting all subsystems from the work vehicle and simultaneously locking the fuel cell assembly and all subsystem connections.

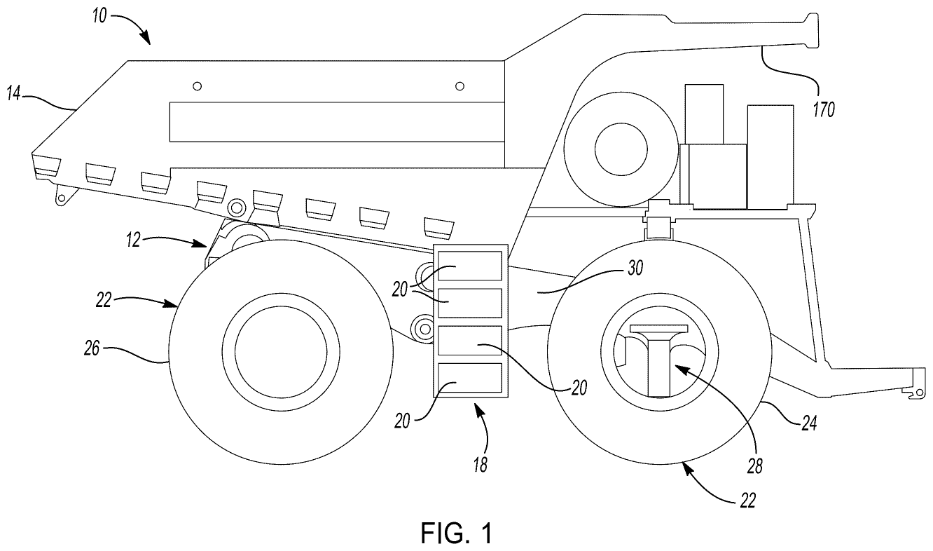

Referring to FIG. 1, a work vehicle 10 is illustrated in accordance with an exemplary embodiment of the present invention. Although illustrated as a mining truck, work vehicle 10 can be any type of vehicle in any suitable industry including, but not limited to, construction, forestry, agriculture, waste management and drilling.

The work vehicle 10 includes a main frame or chassis 12 supporting a dump body 14. Chassis 12 also supports a fuel cell enclosure 18 having a plurality of modular fuel cell assemblies indicated generally at 20. The dump body 14 is movably and/or pivotally connected to chassis 12 and is configured to carry loads (e.g., mined materials, rock, concrete, sand) away from a worksite. The dump body 14 is moved by extensions and contractions of a cylinder (not shown) and may be rotatable relative to chassis 12.

A plurality of wheels 22 are rotatably connected to the chassis 12, as shown in FIG. 1. Plurality of wheels 22 includes a pair of front wheels, one of which is indicated at 24 and a pair of rear wheels, one of which is indicated at 26. Work vehicle 10 may include a drive system (not shown) coupling the plurality of wheels 22 to wheel motors such as indicated at 28 associated with front wheel 24. The modular fuel cell assemblies 20 (20A-20D) are configured to supply power to, for example, wheel motors 28 associated with one or more of the plurality of wheels 22 to propel the work vehicle 10.

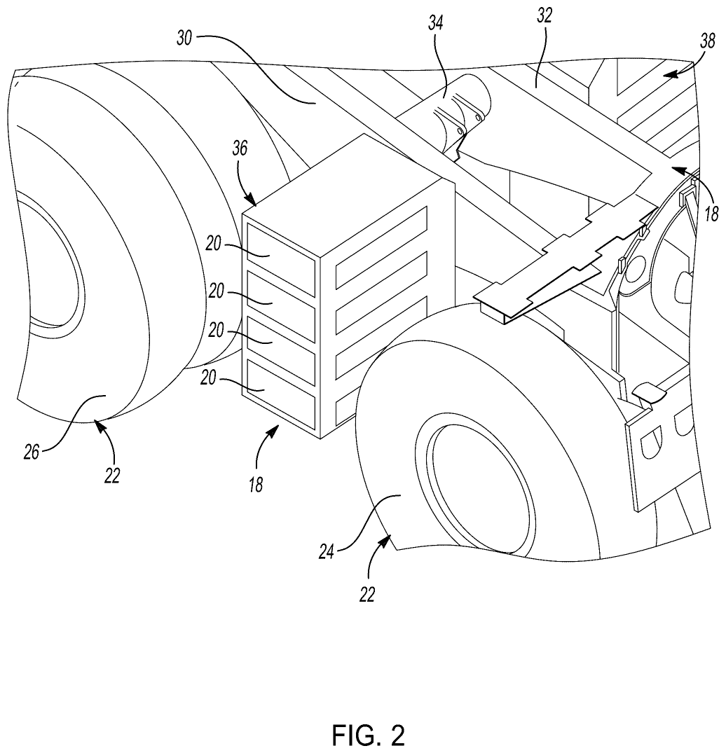

As shown in FIGS. 1 and 2, the chassis 12 includes a first longitudinally extending member 30 and a second longitudinally extending member 32. A plurality of cross members, one of which is indicated at 34 in FIG. 2 extend between inner surfaces (not separately labeled) of the first and second longitudinally extending members 30 and 32 in a lateral or widthwise direction of the work vehicle 10.

In the illustrated embodiments, the work vehicle 10 includes multiple fuel cell enclosures 18 mounted to chassis 12. For example, a first fuel cell enclosure 36 is mounted to first longitudinally extending member 30 and a second fuel cell enclosure 38 is mounted to second longitudinally extending member 32. In one example, each fuel cell enclosure 36, 38 may be configured to generate power in the range of between about 250 KW—and about 2500 KW to supply the work vehicle 10 with between about 500 KW—and about 5000 KW. In another example, each fuel cell enclosure 36, 38 may be configured to generate about 1200 kW to supply the mine truck with about 2400 KW of power. The maximum power generated by fuel cell enclosures 36, 38 may vary and could be determined based on the power demand of the specific work vehicle.

While shown as including two fuel cell enclosures 18, it should be understood that, in certain applications and based on vehicle size and operational requirements a single fuel cell enclosure 18 may be mounted to chassis 12. For example, a smaller mining vehicle 10 may only require a power usage between 500 kW-2400 kW. In such a case, a single fuel cell enclosure 18 can meet such a power requirement.

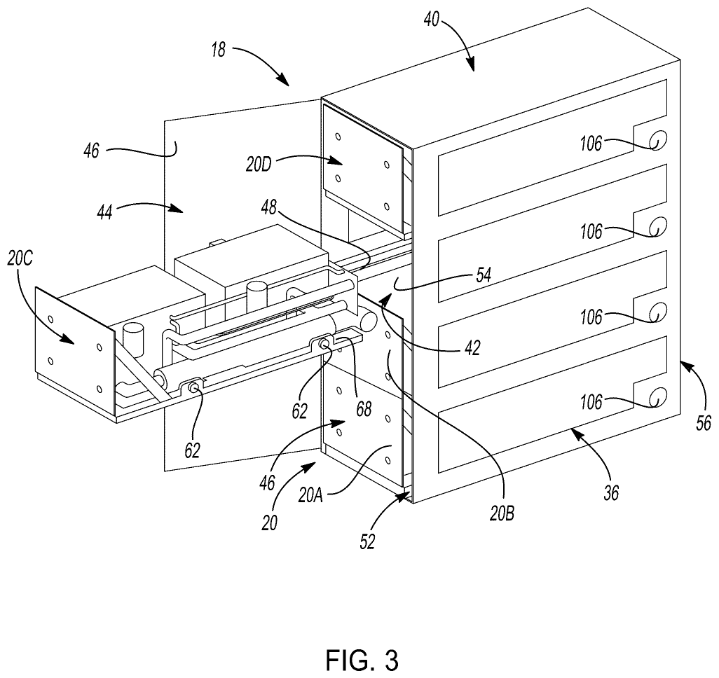

Reference will now follow to FIGS. 3, 4, and 5 in describing first fuel cell enclosure 36 with an understanding that second fuel cell enclosure 38 may be similarly formed. In accordance with the present disclosure, first fuel cell enclosure 36 is mounted to first longitudinally extending member 30 between the front wheel 24 and the rear wheel 26. First fuel cell enclosure 36 may be disposed entirely or partially under the dump body 14. Dump body 14 extends over first fuel cell enclosure 36 to shield internal components from contact with large rocks or other debris from potential damage. First fuel cell enclosure 36 includes a housing 40 having rounded or angled top corners to avoid interference with dump body 14. Housing 40 also includes a plurality of mounts (not shown) that provide an interface with chassis 12. The plurality of mounts may be arranged on side walls and/or top walls.

First fuel cell enclosure 36 may be mounted to chassis 12 so as to create between about a three-to-seven-foot clearance relative to a ground surface between a bottom of the fuel cell enclosure and the ground. As shown in FIG. 1, the fuel cell enclosures 18 may be mounted such that a point on chassis 12 is closer to the ground surface than first fuel cell enclosure 36.

Referring to FIG. 3, housing 40 defines a cavity 42 having a plurality of fuel cell bays 44 that slidably receive modular fuel cell assemblies 20. Housing 40 includes a door 46 that selectively provides access to cavity 42 and/or modular fuel cell assemblies 20. Door 46 is rotatably coupled to the housing 40. For example, door 46 may be coupled to housing 40 through a side-hinged mechanism (not separately labeled) configured to actuate between an open position to provide access to cavity 42 and modular fuel cell assemblies 20 and a closed position during operation of the work vehicle. The side-hinged mechanism may further comprise hydraulic hinges (also not shown) to assist with the actuation and hold the door in either the open or closed position.

In a variation, the door 46 may be hinged at the top of the housing 40 and configured to flip/pivot upwards to access cavity 42 and modular fuel cell assemblies 20. In another variation, door 46 may be formed by a plurality of parallel slats (not shown) fastened together. The plurality of parallel slats may be actuated (e.g., mechanically or electrically) through drive wheels (not shown) disposed inside the housing to slide between open and closed positions. Housing 40 In yet another variation, door 46 may be formed by two or more horizontal or vertical panels with respective couplings that can be independently opened or closed.

The door 46 can be constructed from a metal (e.g., steel, aluminum, etc.) or a composite material for tailored functionality and mechanical strength. For example, door 46 may provide a heat shield or thermal barrier to protect fuel cell enclosures 18 from the environment. First fuel cell enclosure 36 can be installed on various work vehicles for various applications, for example, a mining site. A mine truck will be exposed to various environmental conditions (e.g., rain, heat, etc.), debris, and fine dust. As such, the door 46 may further comprise a seal (not shown) to create an airtight environment inside housing 40. The seal would be positioned to exclude water, debris, or fines from entering inside cavity 42 and interfering with operation with modular fuel cell assemblies 20.

In the illustrated embodiments, the modular fuel cell assemblies 20 are designed to slide in and out of cavity 42 of first fuel cell enclosure 36. The modularity of the modular fuel cell assemblies 20 allows for a quick exchange or swap out in the field (e.g., at the mine site). For example, if one of the modular fuel cell assemblies 20 malfunctions, needs maintenance or repair, that modular fuel cell assembly 20 can be pulled out of the first fuel cell enclosure 36 and swapped with an additional spare modular fuel cell assembly at the mine site. Since the first fuel cell enclosure 36 itself does not require removal, the work vehicle 10 can quickly resume operation and will not experience significant down time during while maintenance is performed at the mine site and/or while the fuel at a repair facility.

As best shown in FIG. 3, modular fuel cell assembly 20 is inserted into housing 40 and shifted into cavity 42. Housing 40 includes guide bars 48, which may be of the same or variable length and shape, are arranged in vertical columns on the left and right sides (not separately labeled) of cavity 42. Guide bars 48 extend from a front 52 of housing 40 including an opening 54 of cavity 42 to a rear 56 of housing 40. The guide bars 48 may form a track system (e.g., c-channel, a ledge, or a linear rail) for the modular fuel cell assemblies 20 to ride on as they are slide in the first fuel cell enclosure 36. Due to the weight of the modular fuel cell assemblies 20, rollers 62 may be installed on a fuel cell assembly support frame 68. Rollers 62 promote a smooth transition for fuel cell assembly support frame 68 as modular fuel cell assemblies 20 are inserted into and out from cavity 42. Rollers 62 may be spring-loaded to dampen and isolate modular fuel cell assembly 20 from vibration during loading and unloading operations. The guide bars 48 and frame 60 may additionally comprise a dampening material (not shown) to isolate the fuel cell assemblies from vibration.

During a loading operation, a fuel cell assembly support frame 68 through rollers 62 engages an upper surface (not separately labeled) of the guide bar 48. Modular fuel cell assembly 20 is then moved toward the rear 56 of cavity 42. A human operator or operator-controlled machine (e.g., a forklift) may load modular fuel cell assembly 20 into first fuel cell enclosure 36 Each modular fuel cell assembly 20 is configured to be independently inserted into and removed from first fuel cell enclosure 36. Additionally, during a loading or replacement operation, one or more of modular fuel cell assemblies 20 may be loaded/unloaded at a time. For example, during a replacement operation, all the modular fuel cell assemblies 20 within the first fuel cell enclosure 36 may be unloaded. In this manner, the modularity, e.g., removal and insertion of the modular fuel cell assemblies 20 without the need to disconnect first fuel cell enclosure 36 eliminates the down time required to remove an entire fuel cell enclosure to send to repair.

Modular fuel cell assemblies 20 are shown as being arranged in a vertical stack in first fuel cell enclosure 36. In the non-limiting example shown, first fuel cell enclosure 36 includes four fuel cell bays 44 that receive a corresponding four modular fuel cell assemblies 20A-20D. It should be understood the number and arrangement of modular fuel cell assemblies 20 in first fuel cell enclosure 36 may vary. For example, modular fuel cell assemblies 20 may be arranged in a horizontally disposed orientation with horizontally disposed guide bars.

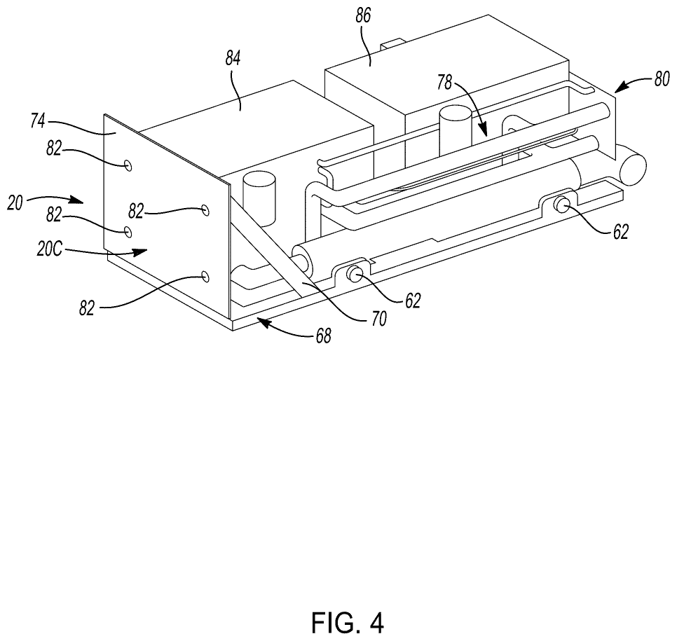

Referring to FIG. 4, wherein like reference numbers represent corresponding parts in the respective views, fuel cell assembly support frame 68 includes a frame 70 having, a front panel 74, a plurality of conduits 78 and a multi-coupling interface (MCI) 80. Front panel 74 may comprise a plurality of holes 82 configured for engagement with a loading/unloading machine. For example, during a loading/unloading operation, the front panel 74 may be bolted to a forklift through the plurality of holes 82. In a variation, two grooves (not shown) may be recessed below the front panel 74 to engage with the forks of a forklift.

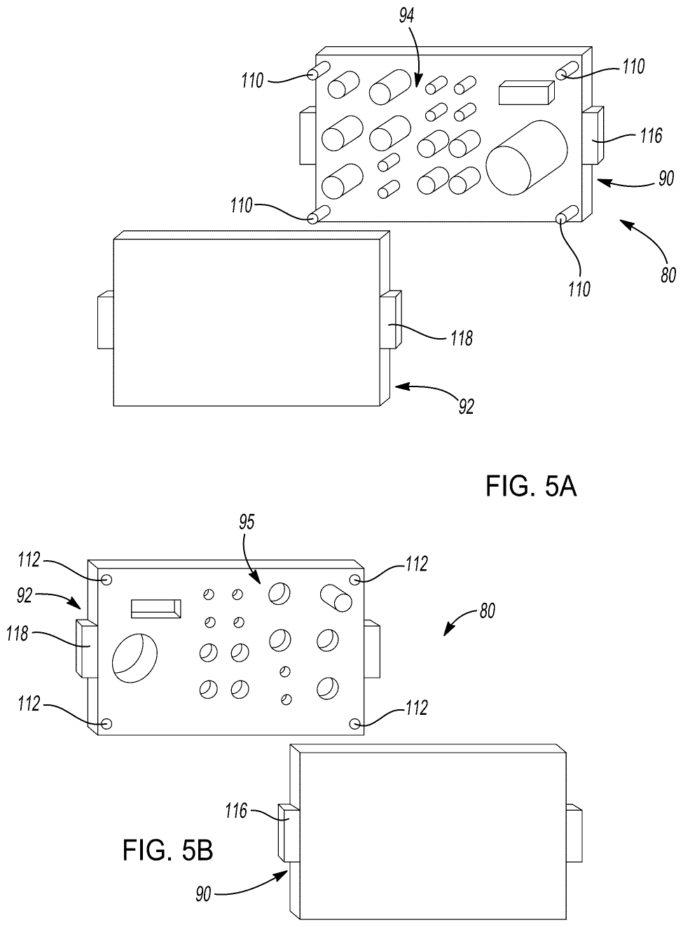

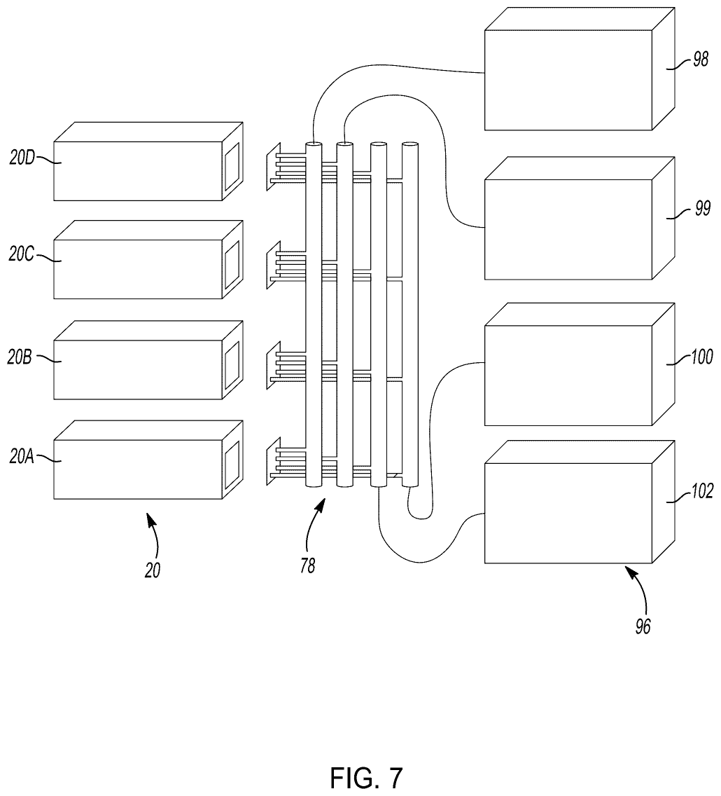

In a non-limiting example, a first modular fuel cell assembly 84 and a second modular fuel cell assembly 86 are mounted to fuel cell assembly support frame 68. First modular fuel cell assembly 84 and second modular fuel cell assembly 86 are connected to multi-coupling interface (MCI) 80 through conduits 76. As shown in FIG. 5, multi-coupling interface 80 includes a first interface member 90 fixedly mounted to first fuel cell enclosure 36 in cavity 42 and a second interface member 92 mounted to frame 70 of fuel cell assembly support frame 68. First interface member 90 includes a plurality of couplers 94 which, as will be detailed more fully herein, connect with fuel cell supply and delivery sources 96 (FIG. 7) including liquid hydrogen supply 98, coolant supply 99, electrical interfaces 100 that feed the drive system, and air filters 102. Second interface member 92 may include a second plurality of connectors 95 that interface with first modular fuel cell assembly 84 and second modular fuel cell assembly 86. In one non-limiting example, housing 40 may include air intake openings 106 (FIG. 3) that provide an air supply to first modular fuel cell assembly 84 and second modular fuel cell assembly 86 through air filter 102.

MCI 80 is used to simultaneously connect the individual conduits 78 and manifolds of each modular fuel cell assembly 20 to the work vehicle. Couplers 94 may take the form of dry quick disconnect couplers that establish a fluid/electrical flow between each modular fuel cell assembly 20 and the work vehicle 10. The engagement of the first plurality of couplers 94 and the second plurality of couplers 95 provide a sealed connection for fluid/electrical flow between the adjacent conduits 78, cables. In some embodiments, the MCI 80 may be a singular plate connected to the rear of the fuel cell enclosure 18 without departing from the principles of the disclosure.

To protect and align the plurality of couplers 94 and 95, the first interface member 90 further comprises a plurality of guide pins 110 configured to engage a respective pin hole 112 in second interface member 92 during loading of the modular fuel cell assemblies 20 into first fuel cell enclosure 36. The guide pins 110 ensure a selected alignment between first interface member 90 and second interface member 92 to ensure a robust and leak-free connection.

During a loading operation, the modular fuel cell assembly 20 is inserted into cavity 42 pushed toward the rear 56 of housing 40 along the guide bars 48. An external force is applied until the second interface member 92 is coupled to the first interface member 90 of MCI 80. Upon connecting, an operational connection is established between fuel cell supply and delivery sources 96 and modular fuel cell assembly 20. First interface member 90 may include a first sensor 116 and second interface member 92 may include a second sensor 118 that confirm that the fluidic connection is established. Once confirmed, modular fuel cell assembly 20 is locked into position. Sensors 116 and 118 may also provide an alert upon detecting a disconnection of MCI 80 or a misalignment between first interface member 90 and second interface member 92. Sensors 116 and 118 may also be configured to trigger an alert when a level of vibration exceeds a predetermined threshold. The modular fuel cell assembly 20 locks into place in the first fuel cell enclosure 36 and all subsystem connections are simultaneously completed through a multi-coupling interface (MCI) 80.

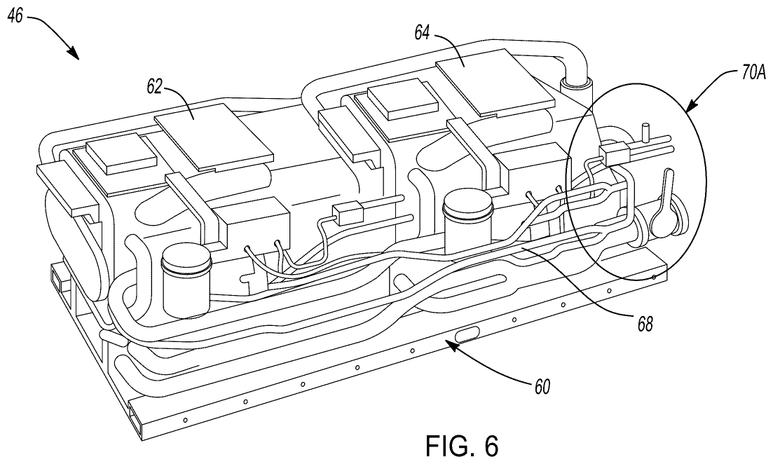

Turning to FIG. 6 instead of MCI 80, one or more leak-free valves or a dry-disconnect valves 70A are implemented, as another embodiment, to facilitate fluid flow between each fuel cell assembly and the work vehicle 10.

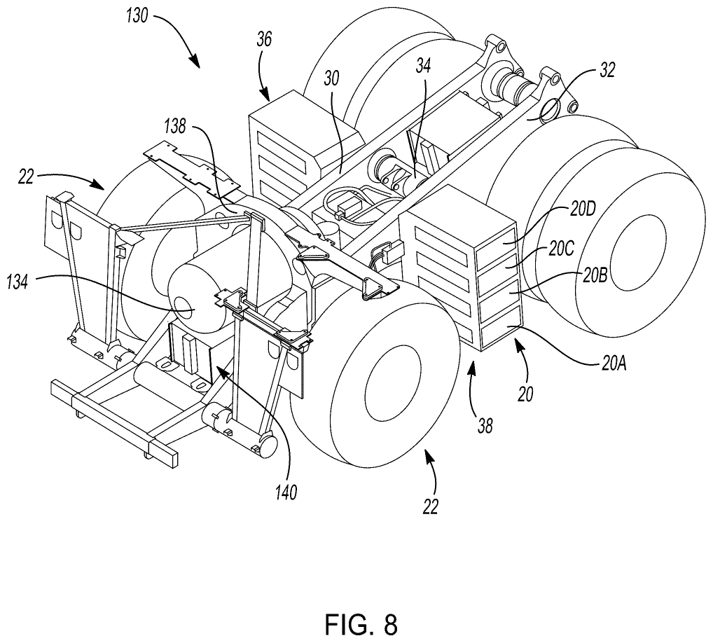

A mining truck 130 supporting the first fuel cell enclosure 36 and second fuel cell enclosure 38 is shown in FIG. 8. A singular liquid hydrogen fuel tank 134 is positioned in the middle of chassis 12 forward of crossmember 34 and between first and second longitudinally extending members 30, 32. The fuel tank 134 stores and delivers pressurized liquid hydrogen, as fuel to each modular fuel cell assemblies 20 within first fuel cell enclosure 36 and second fuel cell enclosure 38. Each modular fuel cell assembly 20 in each fuel cell enclosure 36, 38 is fluidically connected to the fuel tank 134 an associated MCI 80. The fuel tank 134 may hold, for example, liquid hydrogen, gaseous hydrogen or other hydrogen containing fuels.

The fuel tank 134 may be located in-between a horse collar 138 of chassis 12, towards the front of the work vehicle 130. A battery array 140 may additionally be connected to chassis 12 below horse collar 138 and between first and second longitudinally extending members 30 and 32. As shown in this embodiment, the fuel tank 134 is oriented above and may rest upon the battery array 140. In another embodiment, the fuel tank 134 may be coupled between the two longitudinally extending members 30, 32 directly below the dump body 14. Chassis 12 provides additional protection to the fuel tank 104 and minimizes any potential damaging events (e.g., rocks, debris, and the like).

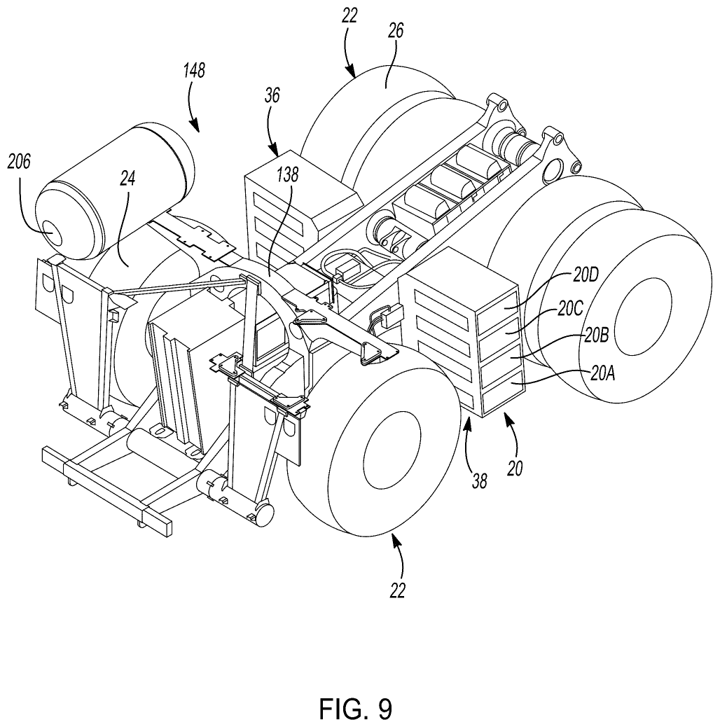

As illustrated in FIG. 9, wherein like reference numbers represent corresponding parts in the respective views, a work vehicle 148, in accordance with another exemplary construction, includes a liquid hydrogen fuel tank 206 mounted directly above one of the front wheels 24. Liquid hydrogen fuel tank 206 extends longitudinally toward the front of the work vehicle 148. Horse collar 138 rigidly connected to chassis 12 may be configured to further support the liquid hydrogen fuel tank 150.

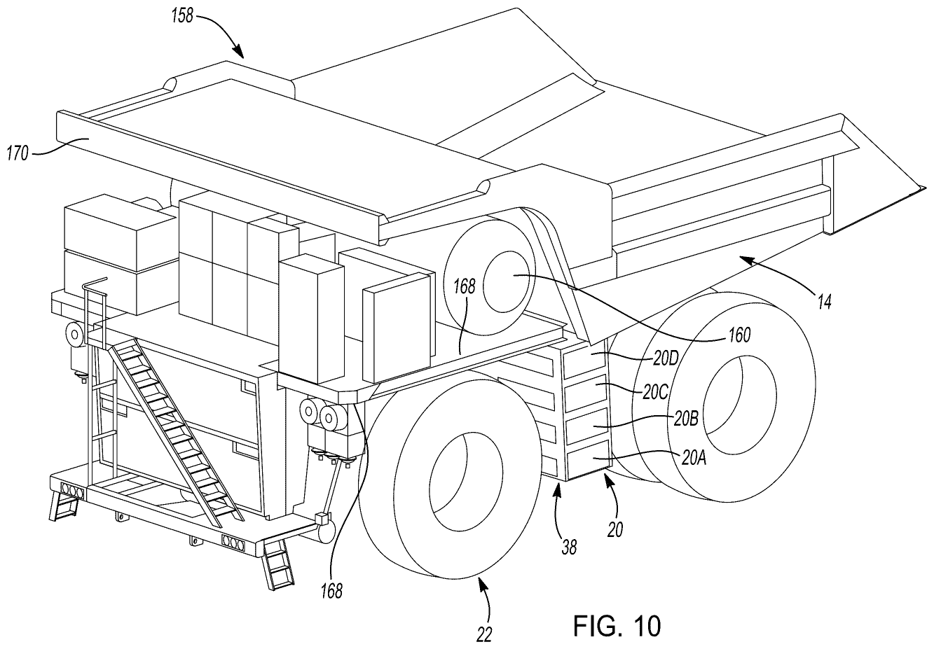

A work vehicle 158, in accordance with another exemplary aspect, is shown in FIG. 10, wherein like reference numbers represent corresponding parts in the respective views. Work vehicle 158 includes a fuel tank 160 located on the deck 168 of the work vehicle 158. In some configurations, the fuel tank 160 may be located on or adjacent to the deck 168 and beneath a canopy 170 of dump body 14. The fuel tank 160 may extend longitudinally along the width of the deck 168. The fuel tank 160 may extend the whole width or a partial width of the deck 168.

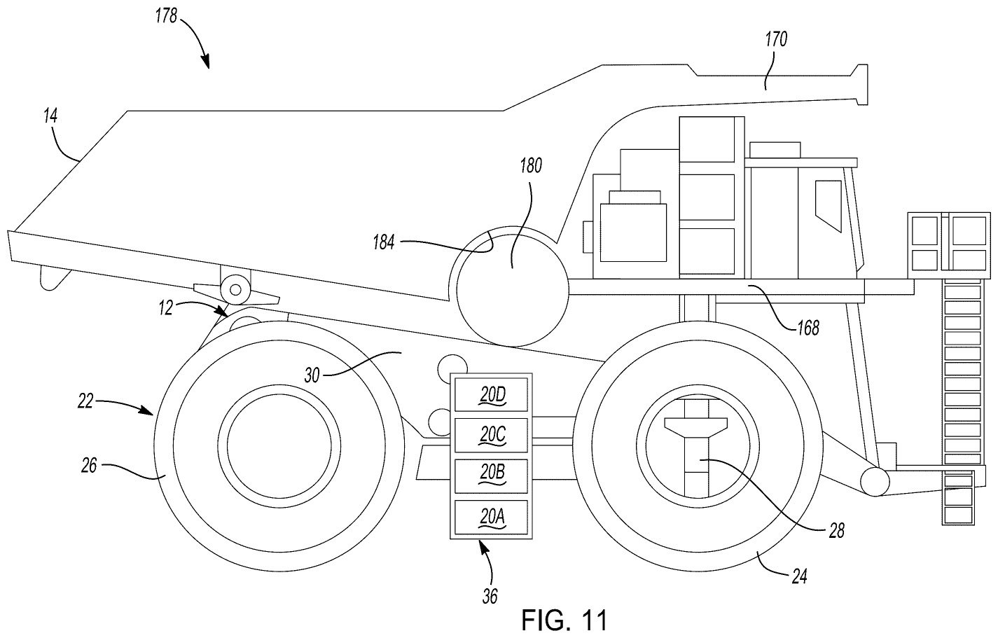

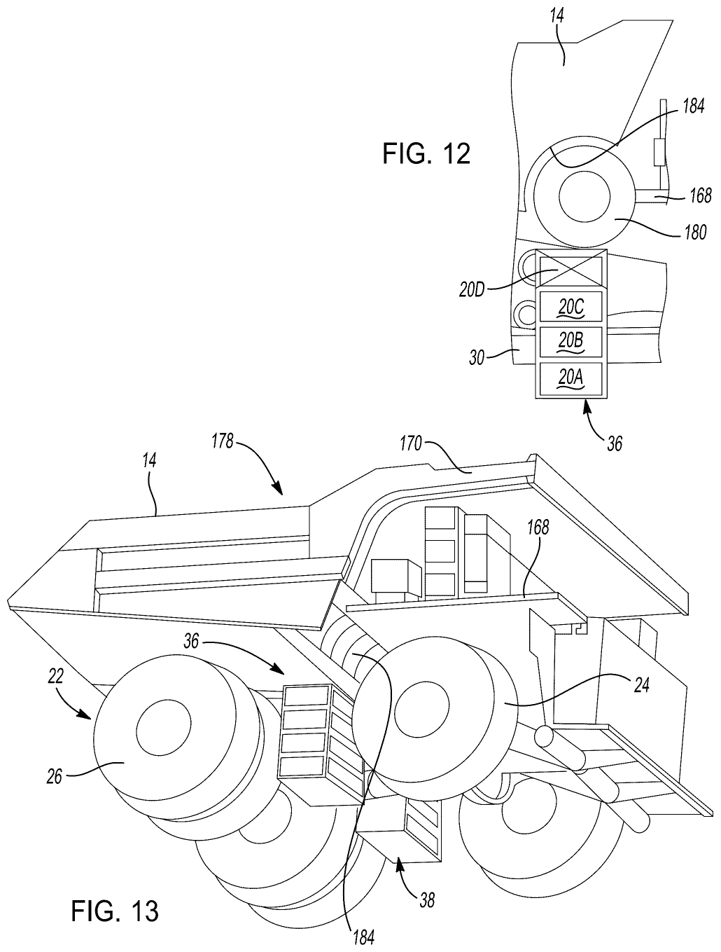

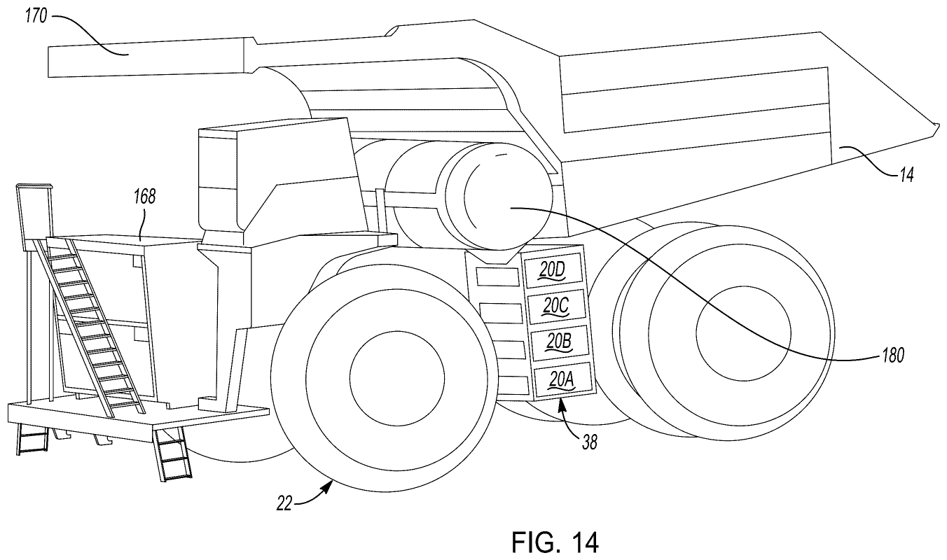

FIGS. 11-15, wherein like reference numbers represent corresponding parts in the respective views, show another embodiment of a work vehicle 178 including a fuel tank 180 (e.g., a liquid hydrogen tank for the fuel cell assemblies) mounted to chassis 12 of the work vehicle 178 at a location behind the deck 168 and beneath a portion of the dump body 14. An underside of the dump body 14 may include a cutout, notch, or recess 184 (FIGS. 12 and 13) formed therein that at least partially receives the fuel tank 180. In other words, the fuel tank 180 may be nested in the recess 184 such that the dump body 14 extends partially around the fuel tank 180.

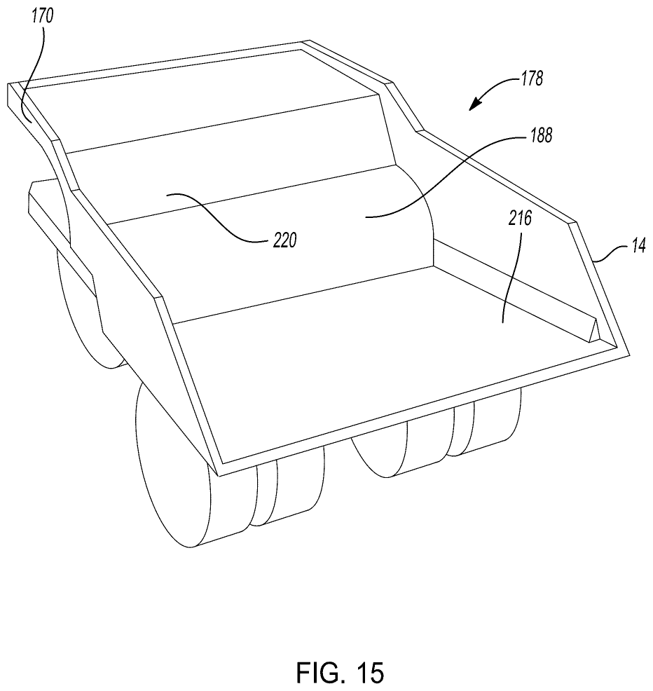

Forming the cutout, notch, or recess 184 in the underside of the dump body 14 results in a ridge or bump 188 (FIG. 15) on the topside (cargo side) of the dump body 14. The bump 188 may span from a lower wall (or floor) 216 of the dump body 14 to a front wall 220 of the dump body 14. The canopy 170 of the dump body 14 may extend forward from the front wall 220.

The bump 188 may reduce the volume capacity of the dump body 14 (i.e., the bump 188 may reduce the volume in which cargo can be hauled by the work vehicle 178), however, this loss in volume capacity may be an acceptable tradeoff for maximizing capacity of the fuel tank 180, maintaining advantageous weight splits of the work vehicle 178, and minimizing overall modifications to the work vehicle 178 to accommodate the fuel tank 180. Advantages of this configuration include good weight distribution, short line lengths to the fuel cell, symmetry of lines routing for fuel cells if placed between front and rear tires, protection from body, the ability to have both large diameter and length thus maximizing tank stored fuel capacity, and truck aesthetics. Furthermore, the loss of volume capacity due to the bump 188 may be offset by increasing the size of the dump body 14 in other locations.

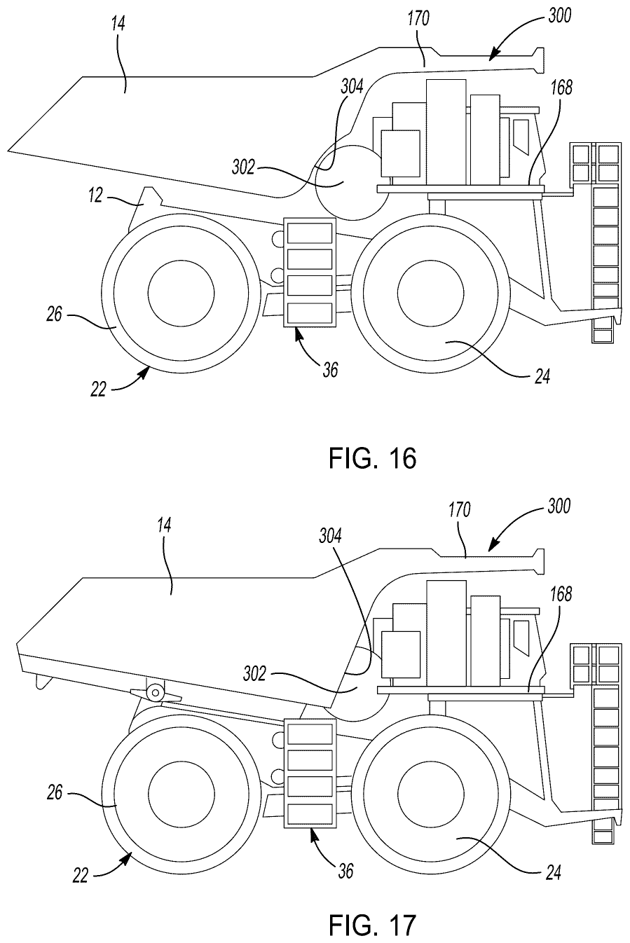

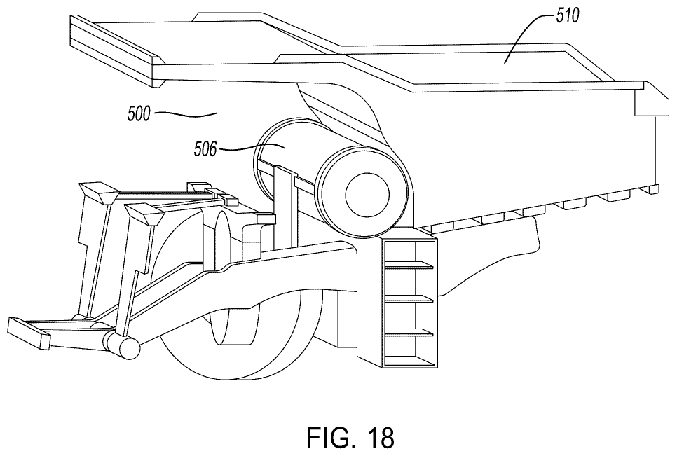

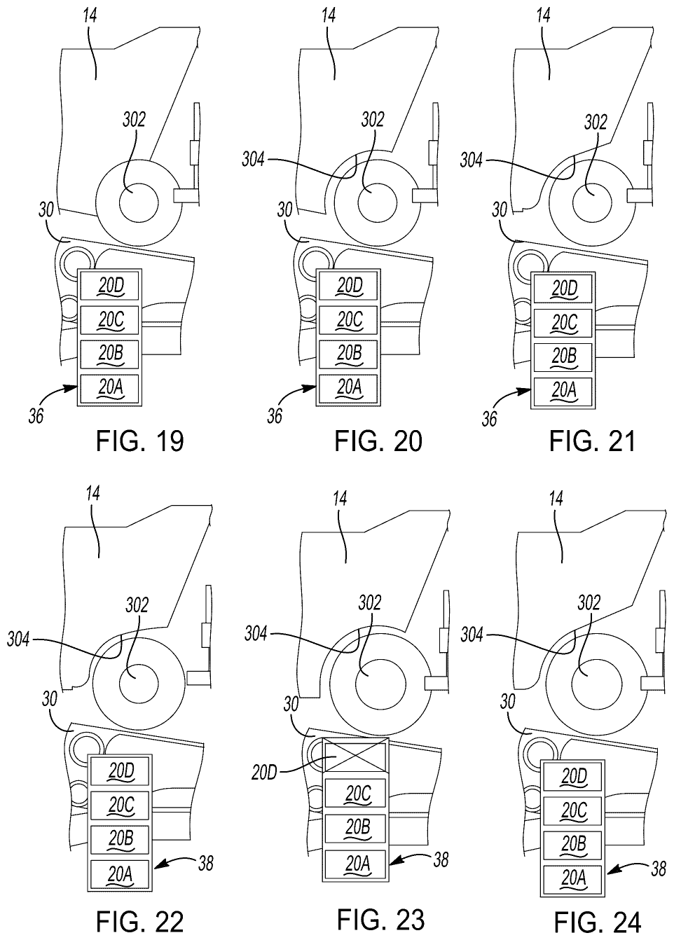

FIG. 16, wherein like reference numbers represent corresponding parts in the respective views, depicts a work vehicle 300 in accordance with another exemplary aspect. Work vehicle 300 includes a fuel tank 302 arranged in a cutout, notch, or recess 304 having different geometry than the recess 184. Other alternative geometries of the recess are shown in FIGS. 17-24.

The terms “about” and “substantially” are intended to include the degree of error associated with measurement of the particular quantity based upon the equipment available at the time of filing the application. For example, “about” and “substantially” can include a range of ±8% of a given value.

The foregoing has been described in relation to a mining truck. It will be apparent to one skilled in the art that the embodiments described herein could likewise be used for other industrial machines. The embodiments described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

What is claimed is:

1. A work vehicle comprising:
a chassis having frame rails;
a cargo bed disposed along the chassis;
an electric motor disposed on the chassis;
one or more fuel cell enclosures disposed under the cargo bed; and
a hydrogen tank disposed above the one or more fuel cell enclosures, wherein the one or more fuel cell enclosures comprise:
a plurality of fuel cells configured to be inserted into the one or more fuel cell enclosures; and
one or more leak-free valves configured to couple the plurality of fuel cells with the work vehicle.

2. The work vehicle according to claim 1, wherein the plurality of fuel cells are disposed on a tray removably inserted into the one of the fuel cell enclosures; and
the one or more leak-free valves are disposed on the tray and is configured to couple the plurality of fuel cells with the work vehicle.

3. The work vehicle according to claim 2 further comprising a conduit configured to couple the plurality of fuel cells and the one or more leak-free valves.

4. The work vehicle according to claim 3, wherein the conduit is disposed on the tray.

5. The work vehicle according to claim 1, wherein the one or more leak-free valves is a multi-port connection coupling having a first plate, a second plate configured to mate with the first plate, and one or more couplers disposed between the first plate and the second plate so that a plurality of fluid flows are enabled through the multi-port connection coupling.

6. The work vehicle according to claim 5, wherein the multi-port connection coupling comprises a sensor that detects abnormality of a connection between the first plate and the second plate.

7. The work vehicle according to claim 6, wherein the sensor is configured to output an alert when a level of vibration in the one or more fuel cell enclosures exceeds a predetermined threshold.

8. The work vehicle according to claim 1, wherein the one or more fuel cell enclosures include a first fuel cell enclosure and a second fuel cell enclosure, and
the first fuel cell enclosure and the second fuel cell enclosure are arranged on an opposite side of the chassis.

9. The work vehicle according to claim 8, wherein the chassis includes a first frame rail and a second frame rail, and
wherein the first and second fuel cell enclosures are respectively attached to the first and second frame rails.

10. The work vehicle according to claim 8, wherein, in each of the first and second fuel cell enclosures, the plurality of fuel cells are disposed on a tray removably inserted into the first and second fuel cell enclosures; and
wherein the trays of each of the first and second fuel cell enclosures are respectively configured to be put in and out of the first and second fuel cell enclosures.

11. The work vehicle according to claim 1, wherein each of the one or more fuel cell enclosures includes an air filter configured to filter air passing into the one or more fuel cell enclosures to each of the plurality fuel cells.

12. A work vehicle comprising:
a chassis having frame rails;
a cargo bed disposed along the chassis;
an electric motor disposed on the chassis;
one or more fuel cells disposed under the cargo bed; and
a hydrogen tank disposed above the one or more fuel cells,
wherein the cargo bed has a recess portion; and
the hydrogen tank is disposed under the recess portion.

13. The work vehicle according to claim 12, wherein:
the recess portion is recessed towards an upper surface of the cargo bed; and
the hydrogen tank is disposed under the recess portion, the hydrogen tank extending along a recessed surface of the recess portion.

14. A work vehicle comprising:
a chassis having frame rails;
a cargo bed disposed along the chassis;
a deck with an operator cab fixed on the chassis;
an electric motor disposed on the chassis;
one or more fuel cells disposed under the cargo bed; and
a hydrogen tank disposed in a vicinity of the deck.

15. The work vehicle of claim 14, wherein the hydrogen tank is disposed behind the deck.

16. The work vehicle of claim 14, wherein the hydrogen tank is disposed between the frame rails of the chassis.

17. The work vehicle of claim 14, wherein the hydrogen tank is disposed above one of front wheels.

18. The work vehicle of claim 14, wherein the hydrogen tank is disposed on the deck.
